(19) United States
(12) Patent Application Publication
(10) Pub. No.: US 2017/0321623 A1
(43) Pub. Date: Nov. 9, 2017

(54) MULTISTAGE THROTTLING AND EXPANSION METHOD FOR SAVING ENERGY AND REDUCING EMISSIONS OF AN ENGINE

(71) Applicant: Ning Tao, Beijing (CN)

(72) Inventors: Ning Tao, Beijing (CN); Shaoping Wang, Madison, WI (US)

(21) Appl. No.: 15/534,498

(22) PCT Filed: Jun. 25, 2015
(86) PCT No.: PCT/CN2015/082306

§ 371 Date: Jun. 9, 2017

(30) Foreign Application Priority Data
Dec. 12, 2014 (CN) 201410759514.5

(51) Int. Cl. F02F 3/02; F02M 25/06; F16J 1/00; F16J 9/00

(52) U.S. Cl. CPC F02F 3/02; F16J 9/00; F02M 25/06; F16J 1/00

(57) ABSTRACT

The present invention discloses an energy-saving and emission-reducing multistage throttling expansion method for engine. In a crevice passage disposed between the combustion chamber and the crankcase, a multistage throttling is disposed for converting pressure energy of the high-pressure blow-by gas into kinetic energy and momentum, and a multistage expansion is disposed for expanding and dissipating the incoming kinetic energy and momentum of the high-velocity blow-by gas into heat, so that to realize the multistage throttling and expansion method, reduce the leaking of the unburned fuel-air mixture and the burned gas, the hydrocarbon emissions hidden in the intra-cylinder carbon deposition and exhaust gas emissions of the engine, and also improve the engine efficiency and the overall performance of the engine.

### TECHNICAL FIELD OF THE INVENTION

The present invention relates to the field of engine parts and accessories, and in particular to an energy-saving and emission-reducing multistage throttling expansion method for engine, which is suitable for gasoline engines, gaseous fuel engines and diesel engines (including off-road engines and motorcycle engines).

### BACKGROUND OF THE INVENTION

Recently, since the emission control for engines is required more and more strictly, it is a great challenge for the development and production of low emission engines. Generally, among the exhaust gas emission pollutants of gasoline engines, the unburned hydrocarbon emissions are dominant and usually account for three fourth or even higher. Therefore, one of the most effective ways to reduce the exhaust gas emissions of an engine as a whole is to reduce the unburned hydrocarbon emissions in the exhaust gases.

Some studies have shown that the decisive factors influencing the unburned hydrocarbon emissions in the exhaust gas emissions of an engine are characteristics of a crevice passage, formed by a cylinder bore wall, a piston and a piston ring set, from the combustion chamber to the crankcase, and the amount of blow-by gas leakage from the crevice passage. Firstly, during the exhaust process of an engine cycle, part of the unburned hydrocarbons hidden in the crevice volumes between the piston and piston rings, the piston and the cylinder bore wall, as well as the piston rings and the cylinder bore wall (mainly a crevice above a first compression piston ring and a part of a crevice between the first compression piston ring and a second compression piston ring) will escape from an exhaust valve together with the burnt gas. Secondly, during the compression stroke, ignition and expansion stroke of an engine cycle, part of the unburned high-pressure fuel-air mixture and the burned high-temperature and high-pressure gas enter the crankcase of the engine through the crevices between the piston and the piston rings as well as the crevices between the piston and the cylinder bore due to a large difference in pressure, so that the blow-by gas leakage of the unburned fuel-air mixture and the burned gas is caused. The blow-by gas leakage generally will result in the rise of temperature and pressure of the oil in the crankcase so as to form oil vapor. The oil vapor, together with the blow-by gas of the unburned fuel-air mixture and the burned gas, enters a breather system of the engine. Part of the oil vapor will enter the combustion chamber to participate in combustion to form unburned hydrocarbon emissions which are exhausted out from the exhaust valve along with the burnt gas. Thirdly, the sustained combustion of the engine oil will form carbon deposition on the top of the piston and on the surface of the combustion chamber. The formation of the carbon deposition will provide a hotbed for unburned hydrocarbons, and the unburned hydrocarbons hidden in the carbon deposition will escape from the exhaust valve together with the burnt gas during the exhaust process. Apparently, the amount of blow-by gas leakage of the unburned fuel-air mixture and the burned gas has a non-negligible and direct impact on the unburned hydrocarbon emissions.

In an existing engine, since a crevice passage formed by a piston, a corresponding piston ring set and a cylinder bore wall is unable to generate high enough resistance and energy-dissipation effect, it is very difficult to avoid a large amount of blow-by gas leakage of the unburned high-pressure fuel-air mixture and the burned high-temperature and high-pressure gas, and the effect is limited even if various methods for reducing the crevices are tried.

### SUMMARY OF THE INVENTION

A technical problem mainly to be solved by the present invention is to provide a energy-saving and emission-reducing multistage throttling expansion method for engine, which converts the pressure energy of the high-pressure blow-by gas into kinetic energy and momentum by providing a throttling and then dissipates the kinetic energy and momentum of the high-velocity blow-by gas into heat by providing an expansion. The key of the multistage throttling and expansion method is to build a crevice passage with a multistage throttling and expansion function between the combustion chamber and the crankcase of an engine. The crevice passage will generate high enough flow resistance in the compression, ignition and expansion processes of the fuel-air mixture of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The theory and implementation of the energy-saving and emission-reducing multistage throttling expansion method for engine of the present invention can not only greatly and effectively reduce the intra-cylinder carbon deposition and the hydrocarbon emissions in the exhaust gas emissions of the engine, but also significantly improve the engine efficiency and the overall performance of the engine, so that the present invention is suitable for wide applications.

To solve the abovementioned technical problem, the energy-saving and emission-reducing multistage throttling expansion method for engine is provided, the engine comprises: a combustion chamber; a crankcase; a crevice passage with a multistage throttling and expansion function disposed between the combustion chamber and the crankcase; wherein, the crevice passage comprises a cylinder bore body with an inner wall, a piston body, a first compression piston ring, a second compression piston ring and an oil ring assembly; at least one stage of throttling and expansions is disposed in turn in the crevice passage underneath the combustion chamber, passing the piston body, the first compression piston ring, the second compression piston ring and the oil ring assembly to the crankcase; in each stage of throttling and expansion, the ratio of the radial dimension of the crevice passage at the position of the throttling to the radial dimension of the crevice passage at the position of the adjacent expansion is less than 1.0; and, the multistage throttling and expansion method comprises the following steps:

a. a first-stage throttling converts pressure energy of the high-pressure blow-by gas formed by part of the unburned high-pressure fuel-air mixture and burned high-temperature and high-pressure gas inside the combustion chamber into kinetic energy and momentum of the high-velocity blow-by gas, and the high-velocity blow-by gas with the kinetic energy and momentum converted from the pressure energy enters an adjacent first-stage expansion;

b. the adjacent first-stage expansion expands and dissipates the incoming kinetic energy and momentum of the high-velocity blow-by gas into heat, and the pressure and momentum of the high-velocity blow-by gas are greatly reduced after a large amount of energy has been dissipated;

c. the blow-by gas with the greatly reduced pressure and momentum enters a second-stage throttling and then experiences the above process of converting the pressure energy of the high-pressure blow-by gas into the kinetic energy and momentum of the high-velocity blow-by gas, then the high-velocity blow-by gas with the kinetic energy and momentum converted from the pressure energy enters an adjacent second-stage expansion, and the process of expanding and dissipating the kinetic energy and momentum of the high-velocity blow-by gas into heat is performed so that the pressure and momentum of the blow-by gas are greatly reduced again; and

d. the above steps are repeated; and, after multiple times of the throttling and expansion processes with high dissipations, both the pressure energy and kinetic energy of the high-pressure blow-by gas have been exhausted, and the blow-by gas has no spare momentum to enter the crankcase, so that the purpose of preventing blow-by gas leakage is achieved.

As a preferred embodiment of the present invention, in each stage of throttling and expansion, the ratio of the radial dimension of the crevice passage at the position of the throttling to the radial dimension of the crevice passage at the position of the adjacent expansion is less than 1.0, preferably 0.1 to 0.5.

As a preferred embodiment of the present invention, a top land, a first compression ring groove, a second land, a second compression ring groove, a third land, an oil ring groove, and a piston skirt or a fourth land are successively disposed on an outer circumference of the piston body from top to bottom.

As a preferred embodiment of the present invention, at least one stage of expansion is disposed between the inner wall of the cylinder bore body and the second land.

Preferably, at least one stage of expansion is further disposed between the inner wall of the cylinder bore body and the third land.

As a preferred embodiment of the present invention, at least one stage of expansion is disposed between the inner wall of the cylinder bore body and the third land.

As a preferred embodiment of the present invention, one stage of expansion is disposed within a crevice region behind the second compression piston ring and within the second compression ring groove.

As a preferred embodiment of the present invention, at least one stage of expansion is disposed between the inner wall of the cylinder bore body and the piston skirt or the fourth land.

As a preferred embodiment of the present invention, one stage of expansion is disposed within a crevice region behind the oil ring assembly and within the oil ring groove.

As a preferred embodiment of the present invention, the throttling comprises the first-stage throttling and the second-stage throttling, and the expansion comprises the first-stage expansion and the second-stage expansion, wherein the first-stage expansion is disposed between the inner wall of the cylinder bore body and the second land, and the second-stage expansion is disposed between the inner all of the cylinder bore body and the third land.

As a preferred embodiment of the present invention, the throttling comprises the first-stage throttling and the second-stage throttling, and the expansion comprises the first-stage expansion and the second-stage expansion, wherein the first-stage expansion is disposed between the inner wall of the cylinder bore body and the second land, and the second-stage expansion is disposed within the crevice region behind the second compression piston ring and within the second compression ring groove.

As a preferred embodiment of the present invention, the expansion further comprises a third-stage expansion, and the third-stage expansion is disposed between the inner wall of the cylinder bore body and the third land.

The present invention has the following advantages: in the energy-saving and emission-reducing multistage throttling expansion method for engine of the present invention, the pressure energy of high-pressure blow-by gas is converted into kinetic energy and momentum by providing a throttling, and the kinetic energy and momentum of high-velocity blow-by gas are then dissipated into heat by providing an expansion. The key of the multistage throttling and expansion method is to build a crevice passage with a multistage throttling and expansion function from the combustion chamber to the crankcase of an engine. The crevice passage will generate high enough flow resistance in the compression, ignition and expansion processes of the fuel-air mixture of an engine cycle, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices. The theory and implementation of the energy-saving and emission-reducing multistage throttling expansion method for engine of the present invention can not only greatly and effectively reduce the intra-cylinder carbon deposition and the unburned hydrocarbon emissions in the exhaust gas emissions of the engine, but also significantly improve the engine efficiency and the overall performance of the engine, so that the present invention is suitable for wide applications.

### BRIEF DESCRIPTION OF THE DRAWINGS

To describe the technical solutions in the embodiments of the present invention more clearly, the accompanying drawings to be used in the description of the embodiments will be briefly described below. Apparently, the accompanying drawings described hereinafter are some of the embodiments of the present invention, and a skilled person in the art can acquire other drawings according to these drawings without any creative effort, in which:

FIG. 1 is a sectional view of a energy-saving and emission-reducing multistage throttling expansion method for engine according to an embodiment of the present invention, i.e., a sectional view of a crevice passage with at least two expansion chambers from the combustion chamber to the crankcase of an engine;

FIG. 2 is a sectional view of a piston body in FIG. 1; and

FIG. 3 is a sectional view of another multistage throttling and expansion method according to the embodiment of the present invention, i.e., a sectional view of a crevice passage with at least three expansion chambers from the combustion chamber to the crankcase of an engine;

in which: 1: cylinder bore body; 2: piston body; 3: first compression piston ring; 4: second compression piston ring; 5: oil ring assembly; 21: top land; 22: first compression ring groove; 23: second land; 24: second compression ring groove; 25: third land; 26: oil ring groove; 27: piston skirt;

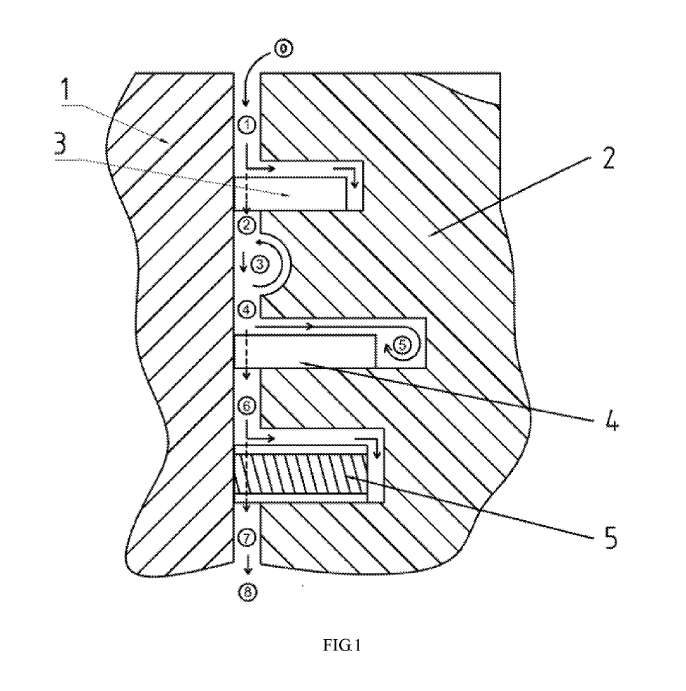

\textcircled{0}: combustion chamber; \textcircled{1}: first-stage throttling (consisting of a crevice e between the top land and the inner wall of the cylinder bore body and a ring gap of the first compression piston ring shown by the first dashed arrow); \textcircled{2}: crevice between an upper portion of the second land and the inner wall of the cylinder bore body; \textcircled{3}: first-stage expansion; \textcircled{4}: second-stage throttling (consisting of a crevice between a lower portion of the second land and the inner wall of the cylinder bore body), with a third-stage throttling consisting of a ring gap of the second compression piston ring shown by the second dashed arrow; \textcircled{5}: second-stage expansion; \textcircled{6}: third-stage expansion (also called a crevice between the third land and the inner wall of the cylinder bore body shown in FIG. 1); \textcircled{7}: crevice between the inner wall of the cylinder bore body and the piston skirt; and, \textcircled{8}: crankcase.

### DETAILED DESCRIPTION OF THE INVENTION

To enable a further understanding of the present invention content of the invention herein, refer to the detailed description of the invention and the accompanying drawings below. Apparently, the embodiments described herein are a part of but not all of the embodiments of the present invention. All other embodiments obtained based on the embodiments in the present invention by one person of ordinary skill in the art without any creative effort shall fall into the protection scope of the present invention.

FIGS. 1-3 show a preferred embodiment of the present invention.

The engine comprises: a combustion chamber \textcircled{0}; a crankcase \textcircled{8}; a crevice passage with a multistage throttling and expansion function disposed between the combustion chamber \textcircled{0} and the crankcase \textcircled{8}; the crevice passage comprises a cylinder bore body 1 with an inner wall, a piston body 2, a first compression piston ring 3, a second compression piston ring 4 and an oil ring assembly 5; at least one stage of throttling and expansion are disposed in turn in the crevice passage underneath the combustion chamber \textcircled{0}, passing the piston body 2, the first compression piston ring 3, the second compression piston ring 4 and the oil ring assembly 5 to the crankcase \textcircled{8}, in each stage of throttling and expansion, the ratio of the radial dimension of the crevice passage at the position of the throttling to the radial dimension of the crevice passage at the position of the adjacent expansion is less than 1.0, preferably 0.1 to 0.5.

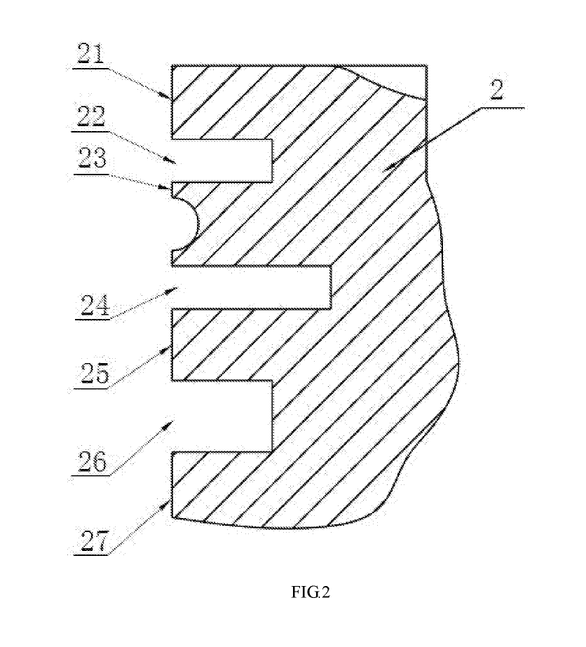

As shown in FIG. 2, a top land 21, a first compression ring groove 22, a second land 23, a second compression ring groove 24, a third land 25, an oil ring groove 26, and a piston skirt or a fourth land 27 are successively disposed on an outer circumference of the piston body 2 from top to bottom.

The pressure energy of the high-pressure blow-by gas is converted into kinetic energy and momentum by providing a throttling, and the kinetic energy and momentum of the high-velocity blow-by gas is then dissipated into heat by providing an expansion. The key of the multistage throttling and expansion method is to build a crevice passage with a multistage throttling and expansion function from the combustion chamber to the crankcase of an engine. The crevice passage will generate high enough flow resistance in the compression, ignition and expansion processes of the mixed fuel-air mixture of the engine, and thus can effectively prevent the unburned high-pressure fuel-air mixture and the burned high-temperature and high-pressure gas from blow-by leaking out from the combustion chamber and the cylinder to the crankcase of the engine; and, in the exhaust process, the crevice passage can ensure that only few hydrocarbon emissions may escape from the crevices.

As shown in FIG. 1, the throttling comprises a first-stage throttling \textcircled{1} (consisting of a crevice between the first land and an inner wall of the cylinder bore body and a ring gap of the first compression piston ring shown by the first dashed arrow) and a second-stage throttling \textcircled{4}; and the expansion comprises a first-stage expansion \textcircled{3} and a second-stage expansion \textcircled{5}.

The multistage throttling and expansion method comprises the following steps:

a. the first-stage throttling \textcircled{1} converts pressure energy of the high-pressure blow-by gas formed by part of the unburned high-pressure fuel-air mixture and the burned high-temperature and high-pressure gas inside the combustion chamber \textcircled{0} into kinetic energy and momentum of the high-velocity blow-by gas, and the high-velocity blow-by gas with the kinetic energy and momentum converted from the pressure energy enters the adjacent first-stage expansion \textcircled{3};

b. the adjacent first-stage expansion \textcircled{3} expands and dissipates the incoming kinetic energy and momentum of the high-velocity blow-by gas into heat, and the pressure and momentum of the high-velocity blow-by gas are greatly reduced after a large amount of energy has been dissipated;

c. the blow-by gas with the greatly reduced pressure and momentum enters the second-stage throttling \textcircled{4} and then experiences the above process of converting the pressure energy of the high-pressure blow-by gas into the kinetic energy and momentum of the high-velocity blow-by gas, then the high-velocity blow-by gas with the kinetic energy and momentum converted from the pressure energy enters the adjacent second-stage expansion \textcircled{5}, and the process of expanding and dissipating the kinetic energy and momentum of the high-velocity blow-by gas into heat is performed so that the pressure and momentum of the blow-by gas are greatly reduced again; and

d. the above steps are repeated; and, after multiple times of the throttling and expansion processes with high dissipations due to the suddenly-converged throttling and expansion mechanisms, both the pressure energy and kinetic energy of the high-pressure blow-by gas have been exhausted, and the blow-by gas has no spare momentum to enter the crankcase \textcircled{8}, so that the purpose of preventing blow-by gas leakage is achieved.

Wherein, the first-stage expansion \textcircled{3} is disposed between the inner wall of the cylinder bore body 1 and the second land 23, and located in the middle of the second land 23; and the second-stage expansion \textcircled{5} is disposed behind the second compression piston ring 4 and within the second compression ring groove 24.

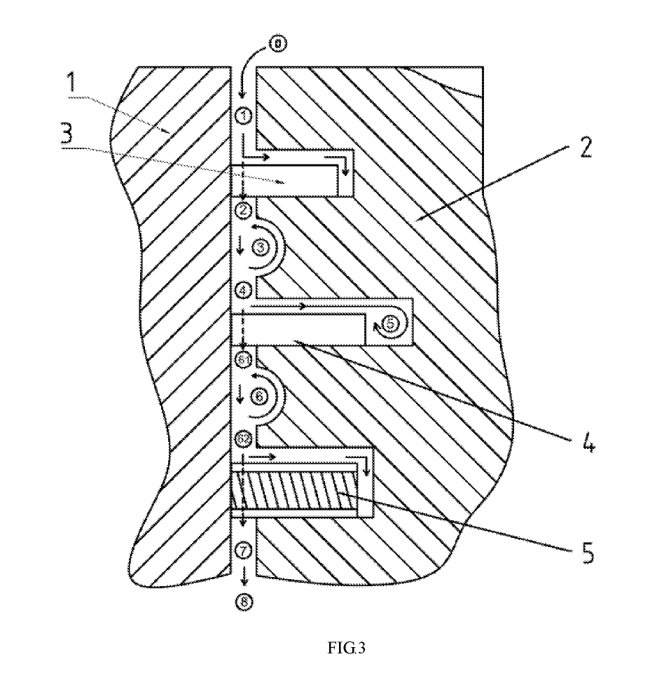

As shown in FIG. 3, the expansion further comprises a third-stage expansion \textcircled{6}. The third-stage expansion \textcircled{6} is disposed between the inner wall of the cylinder bore body 1 and the third land 25.

### Embodiment

There are a top land 21, a first compression ring groove 22, a second land 23, a second compression ring groove 24, a third land 25, an oil ring groove 26 and a piston skirt 27.

Part of the unburned high-pressure fuel-air mixture and burned high-temperature and the high-pressure gas inside the combustion chamber \textcircled{0} form the high-pressure blow-by gas under the influence of great pressure difference, and the high-pressure blow-by gas flows through the first-stage throttling \textcircled{1} (a crevice between the first land 21 and the inner wall of the cylinder bore body 1) and the ring gap of the first compression piston ring 3 (shown by the first dashed arrow) to form a suddenly-converged throttling effect. Then, most of the pressure energy of the high-pressure blow-by gas is converted into kinetic energy and momentum (a small part of the pressure energy is lost due to the first-stage throttling \textcircled{1} and the ring gap of the first compression piston ring 3), and the high-velocity blow-by gas with the kinetic energy and momentum converted from the pressure energy enters the neighboring first-stage expansion \textcircled{3} (a crevice \textcircled{2} between an upper portion of the second land 23 and the inner wall of the cylinder bore body 1, which is a suddenly-enlarged crevice mechanism with regard to the ring gap of the first compression piston ring 3; therefore, actually, the first-stage expansion comprises a small expansion and a large expansion). Subsequently, the first-stage expansion \textcircled{3} expands and dissipates the kinetic energy and momentum into heat. Both the pressure and momentum of the blow-by gas will be significantly reduced after a large amount of energy has been dissipated. The flow-by gas with a reduced pressure enters the second-stage throttling \textcircled{4} (a crevice between a lower portion of the second land 23 and the inner wall of the cylinder bore body 1, which is a radially suddenly-converged crevice mechanism with regard to the first-stage expansion \textcircled{3}) experiences the process of converting pressure energy into kinetic energy and momentum again, and the blow-by gas with the kinetic energy and momentum converted from the pressure energy enters the neighboring second-stage expansion \textcircled{5} (a crevice volume behind the second compression piston ring 4 within the second compression ring groove 24 and an axial crevice between the second compression piston ring 4 and the second compression ring groove 24) and then experiences the process of dissipating kinetic energy and momentum into heat again. At this time, the energy of the blow-by gas has been substantially dissipated out. If there is still spare energy, the blow-by gas will enter the next throttling, i.e., the ring gap of the second compression piston ring 4 (shown by the second dashed arrow from top to bottom or called as a third-stage throttling) and then experience the process of converting pressure energy into kinetic energy and momentum again; then, the blow-by gas with the kinetic energy and momentum converted from the pressure energy (if there still exist the pressure energy and the kinetic energy) will enter a third-stage expansion \textcircled{6} (shown as a crevice between the third land and the cylinder bore wall in FIG. 1 or called a third-stage suddenly-enlarged expansion chamber; although it is a small crevice, it is still an expansion with regard to the ring gap of the second compression piston ring) and then experience the process of dissipating kinetic energy and momentum into heat again. Before a crankcase space \textcircled{8}, other stage of throttling and expansion (not shown) is further provided within a crevice \textcircled{7} between the piston skirt 27 and the inner wall of the cylinder bore body 1 (although it is an annual crevice, it is still an expansion with regard to the ring gap of the oil ring), in order to perform suddenly-converged throttling and suddenly-enlarged expansion effects to intercept possible blow-by gas leakage resulted from spare momentum. In this way, both the pressure energy and the kinetic energy of the high-pressure blow-by gas are greatly reduced. After multiple times of the throttling and expansion processes with high dissipations due to the suddenly-converged throttling and expansion mechanisms, both the pressure energy and kinetic energy of the high-pressure blow-by gas have been exhausted, and the blow-by gas has no spare momentum to enter the crankcase, so that the purpose of preventing blow-by gas leakage is achieved.

In conclusion, in the energy-saving and emission-reducing multistage throttling expansion method for engine of the present invention, the pressure energy of high-pressure blow-by gas is converted into kinetic energy and momentum by providing a throttling, and the kinetic energy and momentum of high-velocity blow-by gas are then dissipated into heat by providing an expansion. The key of the multistage throttling and expansion method is to build a crevice passage with a multistage throttling and expansion function from the combustion chamber to the crankcase of an engine. The crevice passage will generate high enough flow resistance in the compression, ignition and expansion processes of the mixed fuel-air mixture of the engine, and thus can effectively prevent the unburned high-pressure fuel-air mixture and the burned high-temperature and high-pressure gas from leaking out from the combustion chamber and the cylinder to the crankcase of the engine; and, in the exhaust process, the crevice passage can ensure that only few hydrocarbon emissions may escape from the crevices. The theory and implementation of the energy-saving and emission-reducing multistage throttling expansion method for engine of the present invention can not only greatly and effectively reduce the unburned hydrocarbon emissions hidden in intra-cylinder carbon deposition and exhaust gas emissions of the engine, but also significantly improve the engine efficiency and the overall performance of the engine, so that the present invention is suitable for wide applications.

The protection scope of the present invention is not limited to each of embodiments described in this description. Any changes and replacements made on the basis of the scope of the present invention patent and of the description shall be included in the scope of the present invention patent.

1-10. (canceled)

11. A multistage throttling and expansion method for saving energy and reducing emissions of an engine, the engine comprising:
a combustion chamber;
a crankcase;
a crevice passage with a multistage throttling and expansion function disposed between the combustion chamber and the crankcase;
wherein, the crevice passage comprises a cylinder bore body with an inner wall, a piston body, a first compression piston ring, a second compression piston ring and an oil ring assembly;
at least two stages of throttling and expansion are disposed in turn in the crevice passage underneath the combustion chamber, passing the piston body, the first compression piston ring, the second compression piston ring and the oil ring assembly to the crankcase, in each stage of throttling and expansion, the ratio of the radial dimension of the crevice passage at the position of the throttling to the radial dimension of the crevice passage at the position of the adjacent expansion is less than 1.0; and
the multistage throttling and expansion method comprises the following steps:
a. a first-stage throttling converts pressure energy of the high-pressure blow-by gas formed by part of the unburned high-pressure fuel-air mixture and the burned high-temperature and high-pressure gas inside the combustion chamber into kinetic energy of the high-velocity blow-by gas, and then the high-velocity blow-by gas with the kinetic energy and momentum converted from the pressure energy enters an adjacent first-stage expansion;
b. the adjacent first-stage expansion expands and dissipates the incoming kinetic energy and momentum of the high-velocity blow-by gas into heat, and the pressure and momentum of the high-velocity blow-by gas are greatly reduced after a large amount of energy has been dissipated;
c. the blow-by gas with the greatly reduced pressure and momentum enters a second-stage throttling and then experiences the above process of converting the pressure energy of the high-pressure blow-by gas into the kinetic energy and momentum of the high-velocity blow-by gas, then the high-velocity blow-by gas with the kinetic energy and momentum converted from the pressure energy enters an adjacent second-stage expansion, and the process of expanding and dissipating the kinetic energy and momentum of the high-velocity blow-by gas into heat is performed so that the pressure and momentum of the blow-by gas are greatly reduced again; and
d. the above steps are repeated; and, after multiple times of the throttling and expansion processes with high dissipations, both the pressure energy and kinetic energy of the high-pressure blow-by gas have been exhausted, and the blow-by gas has no spare momentum to enter the crankcase, so that the purpose of preventing blow-by gas leakage is achieved.

12. The multistage throttling and expansion method of claim 11, wherein in each stage of throttling and expansion, the ratio of the radial dimension of the crevice passage at the position of the throttling to the radial dimension of the crevice passage at the position of the adjacent expansion is 0.1 to 0.5.

13. The multistage throttling and expansion method of claim 11, wherein a top land, a first compression ring groove, a second land, a second compression ring groove, a third land, an oil ring groove, and a piston skirt or a fourth land are successively disposed on an outer circumference of the piston body from top to bottom.

14. The multistage throttling and expansion method of claim 13, wherein at least two stages of expansions are disposed between the inner wall of the cylinder bore body and the second land.

15. The multistage throttling and expansion method of claim 13, wherein at least one stage of expansion is disposed between the inner wall of the cylinder bore body and the third land.

16. The multistage throttling and expansion method of claim 13, wherein at least one stage of expansion is disposed between the inner wall of the cylinder bore body and the second land; at least one stage of expansions are further provided between the inner wall of the cylinder bore body and the third land.

17. The multistage throttling and expansion method of claim 13, wherein one stage of expansion is disposed within a crevice region behind the second compression piston ring and within the second compression ring groove.

18. The multistage throttling and expansion method of claim 13, wherein at least one stage of expansion is disposed between the inner wall of the cylinder bore body and the piston skirt or the fourth land.

19. The multistage throttling and expansion method of claim 13, wherein one stage of expansion is disposed within a crevice region behind the oil ring assembly and within the oil ring groove.

20. The multistage throttling and expansion method of claim 16, wherein
one stage of expansion is disposed behind the second compression piston ring within the second compression ring groove.

21. The multistage throttling and expansion method of claim 12, wherein a top land, a first compression ring groove, a second land, a second compression ring groove, a third land, an oil ring groove, and a piston skirt or a fourth land are successively disposed on an outer circumference of the piston body from top to bottom.

22. The multistage throttling and expansion method of claim 21, wherein at least two stages of expansions are disposed between the inner wall of the cylinder bore body and the second land.

23. The multistage throttling and expansion method of claim 21, wherein at least one stage of expansion is disposed between the inner wall of the cylinder bore body and the third land.

24. The multistage throttling and expansion method of claim 21, wherein at least one stage of expansion is disposed between the inner wall of the cylinder bore body and the second land; at least one stage of expansions are further provided between the inner wall of the cylinder bore body and the third land.

25. The multistage throttling and expansion method of claim 21, wherein one stage of expansion is disposed within a crevice region behind the second compression piston ring and within the second compression ring groove.

26. The multistage throttling and expansion method of claim 21, wherein at least one stage of expansion is disposed between the inner wall of the cylinder bore body and the piston skirt or the fourth land.

27. The multistage throttling and expansion method of claim 21, wherein one stage of expansion is disposed within a crevice region behind the oil ring assembly and within the oil ring groove.

28. The multistage throttling and expansion method of claim 13, wherein at least one stage of expansions are disposed between the inner wall of the cylinder bore body and the second land, and one stage of expansion is disposed within a crevice region behind the second compression piston ring and within the second compression ring groove.

29. The multistage throttling and expansion method of claim 21, wherein at least one stage of expansions are disposed between the inner wall of the cylinder bore body and the second land, and one stage of expansion is disposed within a crevice region behind the second compression piston ring and within the second compression ring groove.

30. The multistage throttling and expansion method of claim 24, wherein one stage of expansion is disposed within a crevice region behind the second compression piston ring and within the second compression ring groove.
